(19) United States
(12) Patent Application Publication
(10) Pub. No.: US 2012/0317250 A1
(43) Pub. Date: Dec. 13, 2012

(54) METHOD FOR GENERATING A PUBLIC SIP ADDRESS ASSOCIATED WITH A PRIVATE IDENTITY ON AN IMS NETWORK

(75) Inventor: Jean-Yves Fine, Marseille (FR)

(73) Assignee: GEMALTO SA, Meudon (FR)

(21) Appl. No.: 13/576,905

(22) PCT Filed: Feb. 2, 2011
(86) PCT No.: PCT/EP2011/051492

§ 371 Date: Aug. 29, 2012

(30) Foreign Application Priority Data
Feb. 4, 2010 (EP) 10305113.2

(51) Int. Cl. G06F 15/177

(52) U.S. Cl. 709/220

(57) ABSTRACT

The invention relates to a method for generating a permanent public SIP address associated with a private identity on an IMS network. According to the invention, the method consists of applying, to the private identity, a one-to-one, non-reversible and collision-free function in order to obtain the permanent public SIP address. The invention enables the ISIM of an end point to be directly addressed.

The field of the invention is the field of telecommunications in data transmission networks. More particularly, the present invention relates to the generation of a permanent public SIP address associated with a private identity on an IMS (IP Multimedia Subsystem) network.

An IMS network is an IP network connected to an access network. The IMS network provides a dynamic combination of voice, video, messages, data, etc. transfer during the same session. The IMS uses the SIP (Session Initiation Protocol) Protocol to establish and control communications or sessions between users' terminals (also called end points) or between end points and application servers. SIP enables a caller to establish a session by packet switching with a person called (using SIP, User Agents, UAD, installed in the end points), even though the caller does not know the current IP address of the person called before initiating the call.

The current 3GPP IMS specifications require the utilization of a procedure of authentication of the users to the IMS network. Such procedure is described in 3GPP TS 24.229 and 33.203. Using this approach, an identity of the private user (IMPI) and one or more public identities of the users (IMPU) are assigned to the user by the operator. In order to participate in multimedia sessions, the user must register at least one IMPU on the network. The identities are then used by the network to identify the user upon registration and the authentication procedure (the IMPI is used for locating the information relating to the subscribers, such as the user's authentication information, whereas the assignment model indicates the user identity with which the user wishes to interact, and which specific services must be linked with). The IMPI and the IMPUs are stored in a so-called IMS Subscriber identity Module (ISIM) application stored in an integrated circuit card (UICC) in the user's terminal.

Each IMPU is associated to a so-called service profile. The service profile is a set of services and connected data which includes, among other things, the initial filtration criteria which result in a simple service logic for the user (for instance, it defines a set of IMS services that the IMPU public identity will be able to use).

The network giving access to the IMS network is for instance a UMTS, LTE, WLAN and/or Internet network.

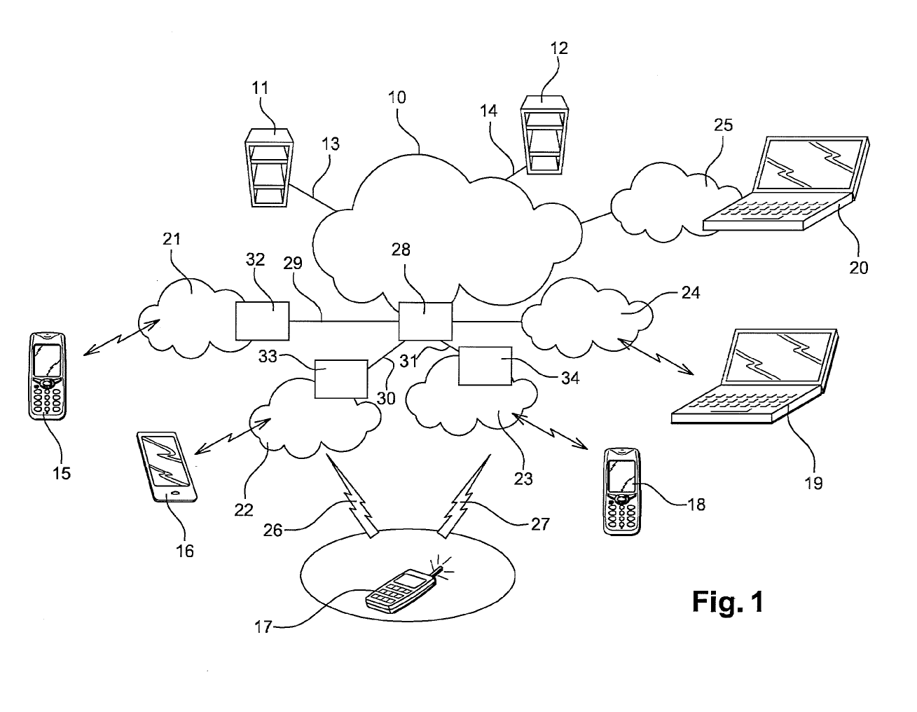

FIG. 1 shows such an IMS network connected to various access networks.

An IMS network 10, such as defined by 3GPP TS 23.228 is connected to application servers 11, 12 by SIP links 13, 14. The servers 11 and 12 host IMS applications representing services such as instant message service, presence management (user present, absent, attending a meeting . . . ), call screening and real time sessions such as voice on IP (VoIP), videoconference, video on demand, video sharing, network games, or television games via IP.

Persons using end points 15 to 20 have access to such services of the IMS network through access networks, such as a UMTS network 21, a LTE (Long Term Evolution) network 22, a 3GPP2 network 23, a WLAN network 24 or an Internet network 25. The terminal 17 communicates through a wireless connection 26 with the LTE network 22 and an EV-DO connection 27 with the 3GPP2 network 23.

The IMS network includes a proxy 28 connected by SIP connections 29 to 31 with interconnection gateways such as a GGSN gateway (Gateway GPRS Support Node) 32, more particularly in charge of supplying an IP address to the end point 15 composed of a GPRS terminal during the whole duration of the connection with the IMS network, a PDN GW gateway (Packet Data Network Gateway) 33 providing the same service for the LTE terminals 16 and 17, and a PDSN gateway (Packet Data Serving Node) 34 providing a connection via the 3GPP2 network 23 of the terminal 18 of the CDMA 2000 type.

Access to the services of the IMS network 10 by the users of the end points 15 to 20 is obtained after the users are connected to their access networks and have requested an IP connection to such IMS network 10. The end points can also communicate with one another through the IMS network, for instance VoIP.

The authentication of the end points by the IMS network 10 is obtained thanks to a private IMPI identity, generally included in a USIM or ISIM application aboard the end points 15 to 20. Each end point has its own private identity. During the request for access to the IMS network 10, an end point send its IMPI to the network 10, and, if authenticated (in a so-called HSS registration server), rights of access will be assigned thereto, according to its profile and to its subscription. The IMS network more particularly bills the user and checks the session.

Each end point 15 to 20 also includes at least one IMPU public (thus not secret) address which enables the user to request and to receive communications with other users or to access a service. The IMPUs are provided as SIP URI (Unified resource Identifier) such as defined in the IETF RFC 3261 and IETF RFC 2396 recommendations. For instance, an IMPU address could be written as:

sip: martin@gemalto.com

or as a phone number:

sip: 0123456789@gemalto.com.

On the contrary, the format of a private IMPI address is of the following type:

<xyz>@gemalto.com,

with <xyz>being a chain of any characters, with the IMPI format being called a Network Access Identifier such as described in the IETF RFC 2486 recommendation.

The IMPUs and the IMPI are conventionally stored in the ISIM application of an end point. The end point may include software which may register IMPUs or the user is given the right to register IMPUs.

If the end point includes no ISIM or USIM application, the IMPUs and the IMPI are stored in a memory of the end point. In a conventional embodiment, the ISIM is stored in a secure element, for instance on a UICC chip card which can be removed from the end point. A UICC card may carry one or more ISIM or USIM applications. The secure element can also belong to the end point.

After or during the authentication of an end point through the recognition of its IMPI and the checking of the secrets it contains, the end point sends one of its IMPU addresses to the HSS of the IMS network 10 in order to be registered therein and to use an IMS service.

The problem to be solved by the present invention is as follows: the private IMPI identity, for instance included in a chip card inserted into a mobile terminal, is transmitted only once to the HLR, during the authentication procedure and the format thereof does not enable the IMS network to directly address the card. It would then be necessary for the mobile terminals to modify the card IMPI into an address looking like an IMPU, so that the network can address the card, for instance, to update data via OTA. This requires a modification and a standardization of the mobile terminals.

Another solution consists in that the card (or the entity containing the IMPI) could manage the procedure of registration with the IMS network. This is equivalent to having two identities registered with the HSS, on the one hand the mobile terminal used as the end point, and on the other hand the card. It must then be possible to establish two secure Ipsec connections cooperating with a proxy on the IMS network (of the HSS), which entails an overload of the proxy and a modification of the IMS network. The operators managing IMS networks must then add such proxies to their networks, which results in additional costs.

The present invention more particularly aims at relieving such drawbacks.

More precisely one of the objects of the invention is to provide a method for generating a permanent public SIP address associated with a private IMPI identity on an IMS network, so that the network can address the entity containing such private identity (card, secure element, end point . . . ) directly and without disclosing the private IMPI identity.

Such object and other ones which shall appear in the following are reached thanks to a method for generating a permanent public SIP address associated with a private IMPI identity on an IMS network, with the method consisting of applying, to said private identity, a one-to-one, non-reversible and collision-free function in order to obtain the permanent public SIP address.

The method according to the invention is preferably implemented in an application of the USIM or ISIM type.

Advantageously, the method is implemented in a secure element giving access to Said IMS network.

In a preferred embodiment, the secure element is a chip card.

In another embodiment, the secure element belongs to an end point giving access to the IMS network.

The invention can be implemented in an element (HSS) in an IMS network.

The invention also relates to a registration by the IMS network of at least one public address different from the permanent public address, with the IMS network implicitly registers said permanent public SIP address according to the 3GPP TS 23.228 V8.9.0 technical specification dated June 2009.

The one-to-one, non-reversible and collision-free function is preferably a SHA-256.

Other particularities and advantages of the invention will appear when reading an advantageous embodiment of the invention, which is given as an illustration and not a limitation, and referring to the appended drawings, wherein:

FIG. 1 has been described while referring to the state of the art;

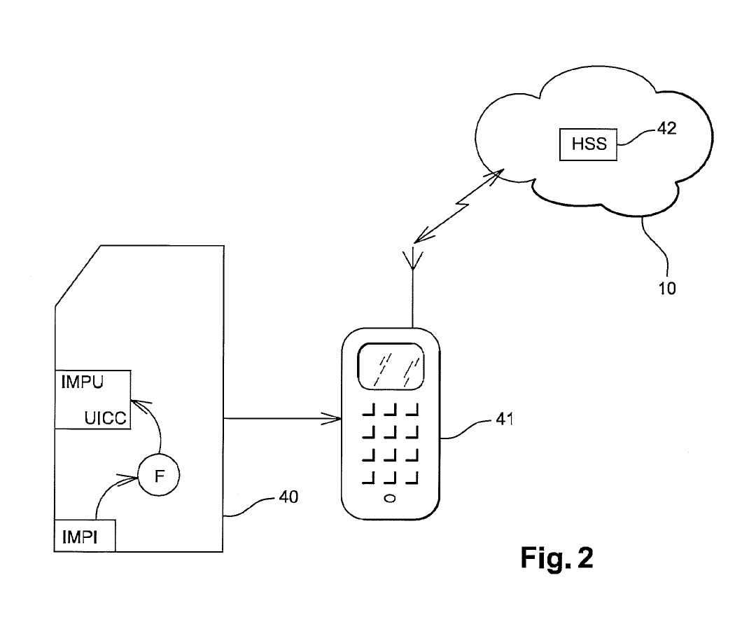

FIG. 2 is a diagram showing the operation of the method according to the present invention.

FIG. 1 has been previously described while referring to the state of the art.

FIG. 2 is a diagram showing the operation of the method according to the present invention.

In this figure, a chip card, for instance of the ID-0 format is included in an end point 41 composed of a mobile radiotelephony terminal. The card 40 includes an ISIM containing a private IMPI identity. According to the invention, it is provided to apply to the private IMPI identity a one-to-one, non-reversible and collision-free function in order to obtain the permanent public SIP address, noted IMPU_{UICC}. The F function must be a one-to-one function so that only one IMPU_{UICC} can correspond to a given IMPI. It must also be reversible, i.e., when the IMPU_{UICC} is known, it must not be possible to deduce therefrom the IMPI from which it was obtained, in order to keep the IMPI secret. Finally, the collision-free property makes it possible to be sure that, when addressing the UICC card (as will be explained in the following), with the IMPU_{UICC} obtained by the F function, the selected UICC and not another UICC having a different IMPI will be addressed.

A public IMPU_{UICC} address of the UICC will then be generated using the F function and inside the UICC 40, from the private IMPI identity thereof.

In a preferred embodiment, the F function is a hatching function of the SHA type, for instance SHA-256. When applying a SHA-256 function to a 128-bit bloc, a 256-bit “hash” is output. With such a F function, if an operation creates 2¹²⁸ different IMPIs, the probability of a collision is 1. For information, an IPV6 address weighs 16 bytes, i.e. 128 bits. Using the theoretical argument of the paradox of anniversaries to guarantee the non-occurrence of collision, the output of the hatching function must then be greater than or equal to 256 bits. The SHA-256 function is thus perfectly adapted for transforming the format of an IMPI into the format of an IMPU.

Another alternative for the F function is SHA-1, SHA-3 or Ripend-160, mainly used in Japan.

As mentioned above, in order to access an IMS service, the UICC 41 transmits a public IMPU address to the IMS network 10 during or after the authentication of the card 40 (by the IMPI thereof), via the mobile terminal 41. The network 10 more particularly includes a registered HSS server noted 42, which includes all the users' IMPIs and IMPUs.

The method of the invention also applies to this registration server 42, which, from the various IMPIs it contains, calculates the resulting SIP IMPU_{UICC} addresses using the same F function, thus not only the IMPIs and IMPUs of the persons having subscribed to the IMS network 10, but also the IMPU_{UICC} obtained using the F function. Upon reception of an IMPU, the registration server 42 carries out an operation known as an implicit registration: the implicit registration consists in associating at least another public address of a subscriber with a public IMPU address of the same subscriber. For instance, if a subscriber transmits a public IMPU₁ address to the HSS 42, such HSS 42 will register not only the IMPU₁ address but other public addresses of this subscriber, noted IMPU_{I}, with i being an integer belonging to [2, n], with n which can theoretically be infinite. If, for instance, n=2, the registration of a public IMPU₁ address by the HSS 42 shall result in the (automatic) implicit registration of the IMPU₂ and IMPU₃ addresses of the same subscriber.

More precisely, a user's IMPUs can be grouped into Implicit Registration Sets (IRS). When the user registers one of his/her IMPUs in an IRS, all the other (not barred) IMPUs within such IRS are also registered in the network. During the registration procedure, the user's terminal is informed about the complete set of the IMPUs which have been implicitly registered in the network further to the registration procedure. The terminal can then use one of the IMPUs to establish outgoing communications and may expect to receive incoming communications from one of such IMPUs. Reference shall be made to the 3GPP TS 23.228 V8.9.0 technical specification dated June 2009 for further information thereon.

In this respect, the invention provides for the association of a subscriber's IMPU_{UICC} with one or more of the subscriber's public IMPU addresses including an UICC according to the invention (including the F function). Thus, for a subscriber, the simple request for registration of one of his/her public addresses will result in the registration of an address matching that of his/her UICC, i.e. IMPU_{UICC}. The IMS network is thus able to directly address the subscriber's UICC, for instance via OTA, in order to make updates therein.

An IMPI and a SIP IMPU_{UICC} address can be matched in the HSS 42, off line or on line: when off line, the HSS calculates the SIP IMPU_{UICC} addresses from the subscriber's private IMPI identities and associates these in a table. Upon receiving an IMPI (during a request for authentication, the HSS recognizes the subscriber's IMPI and knows, in anticipation, the IMPU_{UICC} that will be assigned, through the above mentioned implicit registration procedure, to this subscriber upon the request for registration of an IMPU of this subscriber. In connection mode, the HSS receives the subscriber's IMPI and then computes (using the F function) the SIP IMPU_{UICC} address. Such SIP IMPU_{UICC} address can be stored for matching the associated IMPI (finally, so as not to have to recalculate the IMPU_{UICC} upon each reception of an IMPI). The latter shall be registered via an implicit registration, upon the first request for registration of an IMPU by this subscriber.

In the absence of an ISIM in the end point, the GPRS network uses the IMSI and the MSISDN included in the USIM for generating temporary IMS (IMPI and IMPU) identifiers. The invention also applies as far as such temporary IMPI can be used for generating the IMPU_{UICC}.

The invention is applied, whether the end point includes an UICC or not: the ISIM application can be registered into a portable computer (20, FIG. 1), having access to the Internet connected to the IMS network. A secure element, such as a USB dongle, for instance can also be substituted for the UICC.

1. A method for generating a permanent public SIP address associated with a private identity on an IMS network, comprising applying, to said private identity, a one-to-one, non-reversible and collision-free function to obtain the permanent public SIP address.

2. A method according to claim 1, wherein the method is implemented in an application of the USIM or ISIM type.

3. A method according to claim 1, wherein the method is implemented in a secure element that provides access to said IMS network.

4. A method according to claim 3, wherein said secure element is a chip card.

5. A device according to claim 3, wherein said secure element belongs to an end point that provides access to said IMS network.

6. A method according to claim 1, wherein the method is implemented in an element of an IMS network.

7. A method according to claim 6, wherein said IMS network registers at least one public address different from said permanent public address, and said network implicitly registers said permanent public SIP address according to the 3GPP TS 23.228 V8.9.0 technical specification dated June 2009.

8. A method according to claim 1, wherein said one-to-one, non-reversible and collision-free function is a SHA-256.
